(19) United States
(12) Patent Application Publication
(10) Pub. No.: US 2009/0258259 A1
(43) Pub. Date: Oct. 15, 2009

(54) Catalytic heat exchangers and methods of operation

(76) Inventors: Michael Leshchiner, Needham, MA (US); Christopher O'Brien, Somerville, MA (US); Yanlong Shi, Littleton, MA (US); Darryl Pollica, Melrose, MA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/081,298

(22) Filed: Apr. 14, 2008

(51) Int. Cl. H01M 8/04; H01M 8/18

(52) U.S. Cl. 429/17; 429/20

(57) ABSTRACT

A catalytic heat exchanger comprises a first channel and a second channel, separated by a partition wall. Catalyst coated metal substrates are removably inserted into the first or the second channel or both, which facilitates catalytic reactions in the channel. Energy released in the reaction in one channel is transferred through the partition wall to heat the fluid in the other channel. The catalytic heat exchangers can be used in a fuel processing system to convert hydrocarbon fuels to a hydrogen rich reformate.

The system and methods of operation disclosed herein relate generally to catalytic heat exchangers, the methods of operating thereof, and a fuel processing system incorporating the catalyst heat exchangers. More specifically, disclosed herein are apparatus, systems, and operation methods to use catalytic heat exchangers for converting hydrocarbon-containing fuels to hydrogen-containing reformate.

A catalytic heat exchanger is an apparatus in which hot fluids and cold fluids flow in separate fluid channels. Furthermore, the catalytic heat exchanger also contains catalyst which facilitates catalytic reactions in the hot or the cold fluids. It is traditionally accomplished by providing a catalyst material in one or more of the fluid channels in a heat exchanger. Consequently, the reactants in the fluid experience catalytic reactions and simultaneously transfer energy to another fluid in a different fluid channel. Therefore, a catalytic heat exchanger serves as a reactor as well as a heat exchanger. A catalyst heat exchanger has found applications where there are size constraints, such as in a compact fuel reforming system to produce a hydrogen containing reformate from hydrocarbon fuels.

Reformate is a hydrogen containing gas mixture produced by reforming a hydrocarbon fuel. A low carbon monoxide (e.g. <100 ppm) reformate can be used as the fuel for a polymeric electrolyte membrane fuel cell. In a typical fuel processing system, there are at least four types of catalytic reactions. First is the primary reforming reaction, in which a hydrocarbon-containing fuel is converted to a reformate containing hydrogen, carbon dioxide, carbon monoxide, water, etc. The hydrocarbon-containing fuel can be natural gas, gasoline, diesel, kerosene, or a oxygenated fuel such as methanol, ethanol, etc. The primary reforming reaction can be a steam reforming reaction which involves reactions between fuel and steam, producing a steam reforming process stream; or an autothermal reforming, which involves reactions among fuel, air, and steam, producing an autothermal process steam; or a partial oxidation reaction, which involves partial oxidation of the fuel by air, producing a partial oxidation process stream. The second reaction is the water gas shift reaction where the carbon monoxide in the reformate is oxidized by water to form carbon dioxide. The gas stream in the water gas shift reaction zone is referred to as the water gas shift process stream. The third reaction is the preferential oxidation reaction zone in which the residual carbon monoxide in the reformate is further oxidized, generally by a small amount of air, to below 100 ppm. The gas stream in the preferential oxidation reaction zone is referred to as the preferential oxidation process stream.

A fuel processing system also has a combustion reactor where fuel, e.g. hydrocarbon-containing fuels, hydrogen-rich fuel cell anode exhaust, or reformate itself, are combusted to generate heat. The fluid inside the combustion reaction zone is referred to as the combustion process stream. The exhaust from the combustion reaction zone is referred to as the combustion exhaust stream. In addition to the combustion reaction, water gas shift, and the preferential oxidation reactions are all exothermic, i.e., generating heat, while steam reforming is endothermic, i.e., consuming energy therefore requiring an external heat supply to sustain the reaction.

An autothermal reaction is a complex reaction wherein both exothermic reaction, such as combustion, and endothermic reaction, such as steam reforming, occur simultaneously. When the ratio of air in the reactant relative to the amount of fuel is high, the overall autothermal reaction may be exothermic. However, if that ratio is low, this reaction may also turn endothermic.

All of the reactions mentioned above occur at certain temperature ranges respectively in order to achieve optimum performance, therefore requiring temperature control by either removing heat or supplying heat to the reaction zone. In practice, even an exothermic reaction zone may require external heating to elevate the temperature of the reactants and the catalyst so that the reaction can start and proceed at an acceptable rate. A catalytic heat exchanger serves the functions of a catalytic reactor as well as a heat exchanger. Since it combines a reactor and a heat exchanger into one apparatus, it requires less space than when both a reactor and a heat exchanger are used.

Catalyst in forms of pellets, monolith, or a washcoat may be placed in a catalytic heat exchanger. Directly coating catalyst on a heat transfer surface, however, is difficult. Differences between the thermal expansion of the metallic heat transfer surface and that of the catalyst coating, as well as the attrition between the fluid and the catalyst coating, result in catalyst loss during operation. Only a few selected metals can be used as substrates to coat a catalyst on. Furthermore, coating catalyst on to a pre-assembled heat exchanger typically may leave some interior surfaces inside the heat exchanger uncoated, while assembling pre-coating components into a catalytic heat exchanger frequently results in catalyst loss, contamination, and deactivation. The current disclosure addresses these problems by decoupling the catalyst coating process from the heat exchanger manufacturing process, allowing each process to be carried out separately under the appropriate conditions.

In one of the embodiments of the current disclosure, a catalytic heat exchanger comprises a first channel wherein a first fluid passes through, a second channel wherein a second fluid passes through, a partition wall interposed between the first channel and the second channel, through which energy is transferred between the first fluid and the second fluid, and a catalyst coated metal substrate, wherein one or more of the catalyst coated metal substrates are removably inserted into the first channel or the second channel or both.

It is generally known that an object at a higher temperature may transfer energy to an object which is at a lower temperature. Therefore, in order to accomplish energy transfer from the first fluid to the second fluid the first fluid shall be at a higher temperature at the location where energy is transferred to the second fluid. Among the embodiments of the current disclosure, the first fluid may be at a higher temperature than the second fluid and can transfer energy to the second fluid. For example, the first fluid may be a combustion process stream, an autothermal reforming process stream, a partial oxidation process stream, a water gas shift process stream, or a preferential oxidation process stream. The second fluid can be at a lower temperature than the corresponding first fluid, which may be a steam reforming process stream, an autothermal reforming process stream, an air stream, water or steam, exhaust form the cathode of anode of a fuel cell, a fuel stream, or some combinations thereof. The same process stream, depending on the properties of the other fluid in the catalytic heat exchanger, can either transfer energy out to a lower temperature fluid or receive energy from a higher temperature fluid. For instance, the steam reforming process stream when paired with an autothermal process stream, will receive energy. When it is paired with an air stream or a water stream, it will transfer heat to the air or the water.

Optionally, additional reactant streams can be injected into the process stream. The injection point can be before the process stream enters the channels or inside the channels. Frequently a water stream can be injected into the process stream, either to quickly reduce the temperature of the fluid or to adjust the water content of the fluid.

The disclosure further describes a method of operating a catalytic heat exchanger. The method comprises the steps of first removably inserting catalyst coated metal substrates in a first channel and/or a second channel of the catalytic heat exchanger, then providing a first fluid into the first channel wherein an exothermic first reaction occurs while providing a second fluid into the second channel wherein energy from the first fluid is transferred to, through a partition wall separating the first and the second channel. The exothermic first reaction can be the combustion of fuel, an autothermal reaction, a partial oxidation reaction, a water gas shift reaction, or a preferential oxidation reaction.

In another embodiment of the current disclosure, a fuel processing system has one or more catalytic heat exchangers. The catalytic heat exchanger has the first and the second channel separated by a partition wall. At least one of the first and the second channels has a catalyst coated metal substrate removably inserted therein. A hot fluid passes through the first channel and a cold fluid passes through the second channel. In yet another embodiment of the system, the hot fluid is a preferential oxidation stream and the cold fluid is air, water or steam, an exhaust from the anode or the cathode of a fuel cell, a fuel, or some combinations thereof.

The fuel processing system optionally may have a second catalytic heat exchanger with a configuration similar to the first catalytic heat exchanger. In the second catalytic heat exchanger, the hot fluid can be a combustion fluid stream, while the cold fluid can be a steam reforming process stream. Alternatively, the hot fluid can be a water gas shift process stream, while the cold stream can be air, water or steam, an exhaust from the anode or the cathode of a fuel cell, a fuel stream, or some combinations thereof.

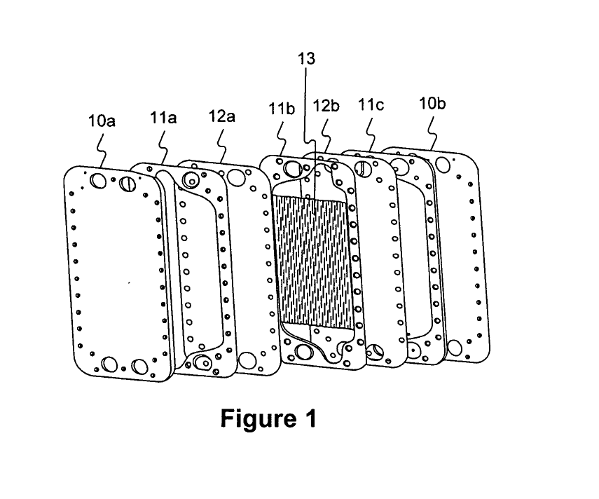

FIG. 1 is a schematic of one embodiment of a catalytic heat exchanger.

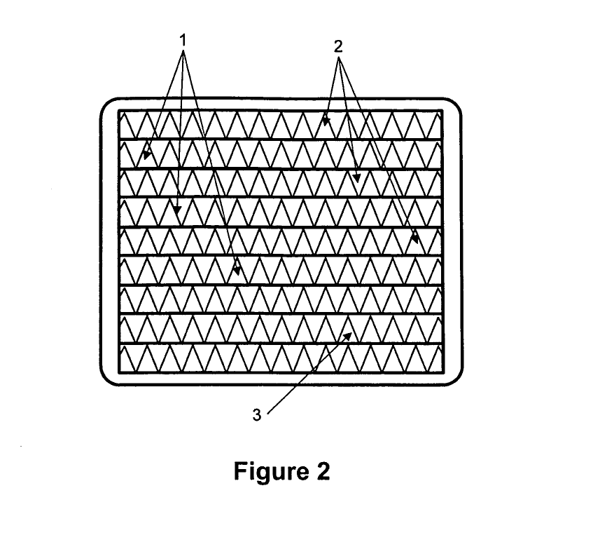

FIG. 2 is a schematic of a cross section of the catalytic heat exchanger perpendicular to the general direction of the fluids.

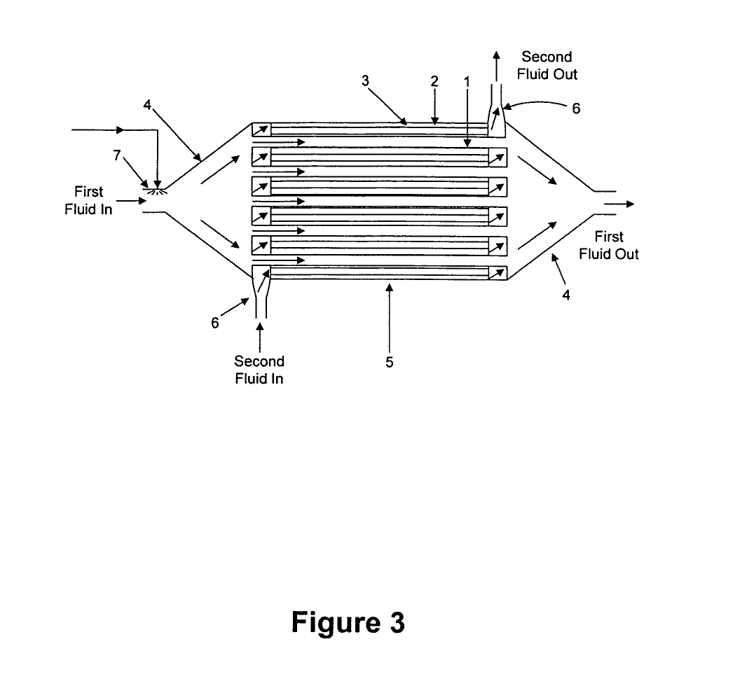

FIG. 3 is an expended view of one embodiment of the catalytic heat exchanger.

In an embodiment of the current disclosure, a catalyst is first coated onto a metal substrate under the proper procedure to form a catalyst coated metal substrate. The metal substrate may be in a variety of sizes, shapes and forms, so long as they can be inserted to the first or the second channels. For instance, it can be a metal strip, a corrugated metal sheet, etc. It can also be a piece of metallic foam or mesh. Suppliers of the metallic foams include Porvair Advanced Materials of Hendersonville, N.C., Sumitomo Electric in Japan, and Inco Special Products in Canada, etc. Suppliers of metallic mesh include Martin Kurz & Co., Inc. of Mineola, N.Y., and Sumitomo Electric in Japan.

The catalytic heat exchanger may be of several configurations, including plate fin or stacked plated designs. The gaps between the plates may constitute fluid channels. FIG. 1 shows some components of a catalytic heat exchanger of the current disclosure. It comprises end plates (10a, b), gaskets (11a, b, c), partition walls (12a, b), and a catalyst coated corrugated metal sheet 13. When assembled, the end plates 10a, gaskets 11a, and partition walls 12a form a fluid channel, while partition wall 12a, gasket 11b, and the partition wall 12b, form another fluid channel in which the catalyst coated corrugated metal sheet 13 resides.

FIG. 2 shows the cross section of an embodiment of the catalytic heat exchanger. The catalytic heat exchanger comprises two types of parallel channels which are separated by partition walls (4). A hot fluid passes through the first channels (1) while cold fluid passes through the second channels (2), or vice versa. Energy is transferred from the hot fluid to the cold fluid. Therefore, in this arrangement, a heat source (i.e., the hot fluid) and a heat sink (i.e., the cold fluid) are place side by side, sharing a heat transfer surface (i.e., the partition wall). The hot fluid may be a high temperature exhaust stream, e.g., a combustion exhaust stream, that needs to be cooled down. The cold fluid may be a stream that needs heating, e.g., a water stream that needs to be heated to steam.

In addition, the channels may contain catalyst coated metal substrates (3). Catalytic reactions occur when the reactants in the fluid come into contact with the catalyst on the metal substrates. The catalytic reaction that requires heat removal acts as a heat source, while the catalyst reaction that requires external heat acts as the heat sink. For instance, steam reforming reaction needs external heating, while combustion requires heat removal to avoid excessively high temperature. Therefore, metal substrates coated with steam reforming catalyst and metal substrates coated with combustion catalyst can be placed into the adjacent channels to facilitate the steam reforming reaction and combustion respectively. Since the channels share relatively large surface area, the heat transfer can be very effective in the catalytic heat exchanger.

After the body of a heat exchanger that contains the channels are completed, and before the channels are sealed to form a closure, the catalyst coated metal substrates are inserted to one or more channels. The metal substrates are removably inserted so that it is not attached to the channel in that it is not welded or brazed or otherwise forms a metal to metal bond with the channel it resides in. Consequently, one can easily remove the catalyst coated metal substrate from the channel, for instance, by pushing or sliding it out from the channel. Once the metal substrates are removably inserted into the channel, one can attach the gas manifold or other types of sealing means to form a closure.

FIG. 3 is a schematic of one of the embodiments of the catalytic heat exchanger. It has three main components: the main body of catalytic heat exchanger (5) having the channels (1) and (2) and catalyst coated metal substrates (3), the gas manifolds for the first fluid (4), and the gas manifolds for the second fluid (6). The gas manifolds (4) guide the first fluid into and out of the first channels while the second gas manifolds (6) guide the second fluid into and out of the second channel without mixing. A fluid injection port 7 is also provided to introduce additional process fluid into the first fluid before it enters the channels. The additional process fluid can be water, steam, fuel, cathode or anode exhausts from a fuel cell, etc.

The catalyst heat exchanger of the current disclosure can be used as a reactor for reactions including steam reforming reaction, autothermal reaction, partial oxidation reaction, water gas shift reaction, preferential oxidation reaction, as well as fuel combustion. It can also be used in preheating reactants, for instance, steam, water, air, fuel, exhausts from fuel cell anode or cathode, or combinations thereof. It can also be used in cooling down process streams, including combustion exhaust stream.

In another embodiment of the current disclosure, different catalysts may be placed in the same channel by coating different catalyst onto the metal substrates and inserting the substrates into the channel. Alternatively, one may insert metal substrates that do not have a catalyst coating. A fuel processing system having multiple reactions may be configured to have one or more catalytic heat exchangers of the current disclosure. For instance, preferential oxidation of the preferential oxidation may occur in a catalytic heat exchanger. The heat generated in the preferential oxidation can be used to heat a cold fluid, e.g., air, water, steam, a fuel cell cathode exhaust, or a fuel cell anode exhaust. The reforming of a hydrocarbon-containing fuel can be accomplished through a steam reforming reaction occurring in another catalytic reactor, wherein the heat to sustain the steam reforming is supplied by a combustion process fluid. When the autothermal reaction is used to convert the hydrocarbon fuel, it is possible that either heat to be added to, or to be taken away from, the autothermal process stream. The autothermal process stream is a cold stream if it is to be heated, likely by a combustion process stream. Conversely, the autothermal process stream can also be a hot fluid, giving away heat to a cold fluid. In addition, the water gas shift reaction may also happen in a catalytic heat exchanger, where the heat generated can heat a cold fluid.

We claim:

1. A catalytic heat exchanger, comprising:
a first channel wherein a first fluid passes through;
a second channel wherein a second fluid passes through,
a partition wall interposed between the first channel and the second channel, through which heat is transferred between the first fluid and the second fluid; and
a catalyst coated metal substrate,
wherein one or more of the catalyst coated metal substrate are removably inserted into the first channel or the second channel or both.

2. The catalytic heat exchanger of claim 1, further comprising at least two catalyst coated metal substrates in the first channel or the second channel, wherein one of the catalyst coated metal substrates is coated with a catalyst material different from a catalyst material coated on another catalyst coated metal substrate in the same channel.

3. The catalytic heat exchanger of claim 1, wherein the metal substrate is selected from a group consisting of a metal strip, a corrugated metal sheet, and a perforated metal sheet.

4. The catalytic heat exchanger of claim 1, wherein the metal catalyst substrate is selected from a group consisting of a piece of metal foam and a piece of metal mesh.

5. The catalytic heat exchanger of claim 1, wherein the first fluid is a combustion process stream or a combustion exhaust stream and the second fluid is a steam reforming process stream or an autothermal reforming process stream.

6. The catalytic heat exchanger of claim 1, wherein the first fluid is an autothermal reformer process stream and the second fluid is selected from a group consisting of fuel, air, water, steam, cathode exhaust from a fuel cell, anode exhaust from a fuel cell, a mixture of air, water and steam, a mixture of water and steam, a mixture of air and steam, and a mixture of fuel, air, water and steam.

7. The catalytic heat exchanger of claim 1, wherein the first fluid is a partial oxidation process stream and the second fluid is selected from a group consisting of fuel, air, water, steam, cathode exhaust from a fuel cell, anode exhaust from a fuel cell, a mixture of air, water and steam, a mixture of water and steam, a mixture of air and steam, and a mixture of fuel, air, water and steam.

8. The catalyst heat exchanger of claim 1, wherein the first fluid is a water gas shift process stream and the second fluid is selected from a group consisting of fuel, air, water, steam, cathode exhaust from a fuel cell, anode exhaust from a fuel cell, a mixture of air, water and steam, a mixture of water and steam, a mixture of air and steam, and a mixture of fuel, air, water and steam.

9. The catalyst heat exchanger of claim 1, wherein the first fluid is a preferential oxidation process stream and the second fluid is selected from a group consisting of fuel, air, water, steam, cathode exhaust from a fuel cell, anode exhaust from a fuel cell, a mixture of air, water and steam, a mixture of water and steam, a mixture of air and steam, and a mixture of fuel, air, water and steam.

10. The catalytic heat exchanger of claim 1, further comprising means for injecting liquid water into the first or the second fluid.

11. A method of operating a catalytic heat exchanger, comprising steps of:
removably inserting one or more catalyst coated metal substrates into a first or a second channel in the catalytic heat exchanger;
providing a first fluid into the first channel wherein an exothermic first reaction occurs; and
providing a second fluid into the second channel wherein energy generated in the first channel transfers through a partition wall interposed between the first and the second channel to the second channel, wherein the transferred energy is used to heat the second fluid in the second channel.

12. The method of claim 11, wherein the exothermic first reaction is combustion and a second reaction occurring in the second channel is a steam reforming reaction or an autothermal reforming reaction.

13. The method of claim 11, wherein the amount of catalyst in the catalytic heat exchanger is adjusted by varying the geometric surface area of the metal substrate whereon the catalyst is coated or by varying the number of the metal substrates the catalyst is coated on.

14. A fuel processing system, comprising:
a reactor wherein a fuel is converted to a reformate stream;
a first catalytic heat exchanger comprising a first channel wherein a first fluid passes through, a second channel wherein a second fluid passes through, a partition wall interposed between the first channel and the second channel, through which energy is transferred between the first fluid and the second fluid;
a catalyst coated metal substrate wherein one or more of the catalyst coated metal substrate are removably inserted into the first channel or the second channel or both,
wherein the first channel contains one or more catalyst coated metal substrates and the first fluid is a preferential oxidation process stream,
wherein the reformate stream is fluidly connected with the preferential oxidation stream.

15. The fuel processing system of claim 14, further comprising:
a second catalytic heat exchanger comprising a first channel wherein a first fluid passes through, a second channel wherein a second fluid passes through, a partition wall interposed between the first channel and the second channel, through which energy is transferred between the first fluid and the second fluid;
a catalyst coated metal substrate wherein one or more of the catalyst coated metal substrate are removably inserted into the first channel or the second channel or both,
wherein the first channel in the second catalytic heat exchanger contains one or more catalyst coated metal substrates, the first fluid in the second catalytic heat exchanger is a water gas shift process stream, and the reformate stream is fluidly connected with the water gas shift process stream.

16. The fuel processing system of claim 14, further comprising:
a third catalytic heat exchanger comprising a first channel wherein a first fluid passes through, a second channel wherein a second fluid passes through, a partition wall interposed between the first channel and the second channel, through which energy is transferred between the first fluid and the second fluid;
a catalyst coated metal substrate wherein one or more of the catalyst coated metal substrate are removably inserted into the first channel or the second channel or both,
wherein the first channel of the third catalytic heat exchanger contains one or more catalyst coated metal substrates, the first fluid in the third catalytic heat exchanger is an autothermal reforming process stream, and the reformate stream is fluidly connected with the autothermal reforming process stream.

17. The fuel processing system of claim 14, wherein the second channel of the first catalytic heat exchanger has no catalyst coated metal substrate inside and the cold fluid therein is selected from a group consisting of fuel, air, water, steam, cathode exhaust from a fuel cell, anode exhaust from a fuel cell, a mixture of air, water and steam, a mixture of water and steam, a mixture of air and steam, and a mixture of fuel, air, water and steam.

18. The fuel processing system of claim 14, wherein the second fluid in the first catalytic heat exchanger is selected from a group consisting of fuel, air, water, steam, cathode exhaust from a fuel cell, anode exhaust from a fuel cell, a mixture of air, water and steam, a mixture of water and steam, a mixture of air and steam, and a mixture of fuel, air, water and steam.

19. The fuel processing system of claim 15, wherein the fuel is selected from a group consisting of natural gas, ethanol, methanol, propane, gasoline, diesel, and kerosene.
